(19) United States
(12) Patent Application Publication
(10) Pub. No.: US 2004/0168387 A1
(43) Pub. Date: Sep. 2, 2004

(54) Method and apparatus for sealing windows of a building

(76) Inventor: David Nelson, Sunol, CA (US)

Correspondence Address: MARK A LAUER, 6601 KOLL CENTER PARKWAY, SUITE 245, PLEASANTON, CA, 94566, US

(21) Appl. No.: 10/377,390

(22) Filed: Feb. 28, 2003

(51) Int. Cl. E06B 3/00; E04B 9/00

(52) U.S. Cl. 52/344; 52/481.1

(57) ABSTRACT

A method and apparatus for forming a waterproof building wall is disclosed, including providing a mold that fits around a window or other structure held in the wall, applying stucco or other moldable material that hardens to form an exterior coating for the wall and a recess from the mold, and sealing the recess with an elastic and waterproof sealant that is attached to both the structure and the side of the recess. The resulting wall may have a sealed recess between the stucco coating and the structure that extends less than about one centimeter from the structure, and the seal can expand and contract in conformance with expansion and contraction of a distance between the edge and the side surface.

### TECHNICAL FIELD

The present application relates to sealing building walls containing structures that are exposed to the exterior of the building, such as windows, pipes and doors.

### BACKGROUND

Provision of buildings with interior regions that are protected from the elements is one of the most basic and longstanding human needs. Various forms of wall materials are commonly employed, such as wood, masonry, concrete and stucco. Typically, glass windows are attached to the walls with window frames, which are commonly made of wood, aluminum or vinyl. Areas at which window frames or other structures meet building walls sometimes have leaks that allow air and/or water to enter the walls, and so those areas are typically protected with waterproofing such as flashing.

For new construction of homes in North America, walls are commonly built with wood frames and stucco exterior coatings. In this case, building paper is stapled to the exterior side of the wood wall frame, and then a wire mesh is nailed to the frame through the building paper. The wire mesh provides support for one or more layers of portland cement plaster that hardens to form a stucco coating for the exterior wall. Water that seeps through the stucco coating, for example via cracks that may develop in the stucco, is designed to be obstructed by the building paper and drip to the bottom of the stucco coating, where it is diverted outside the wall again at a weep screed.

To build a wall containing a window opening or other structure that pierces the stucco layer, the structure is first attached to wood support members such as the studs, lentil and sill plate that form a rough opening in the wall. Flashing material is then typically attached to the support members surrounding the structure prior to attachment of the building paper. Despite these precautions, moisture sometimes penetrates the wall from the exterior to cause damage. Prolonged exposure to moisture can cause the wood in the walls to rot, and excessive moisture can ruin interior elements such as carpet and wallboard. Even temporary exposure to moisture can cause mold to develop, which may cause respiratory and other problems in some people.

FIG. 1 shows a window 20 that has a vinyl frame 22 attached to a wall that is coated with stucco 25. The vinyl frame 22 may expand and contract more than the stucco wall coating 25, causing leaks to develop at a juncture between the frame and the stucco. To repair such leaks the stucco that is located within about one foot of the window may be removed, after which the window flashing may be repaired and the removed stucco replaced. Unfortunately, the window frame may again expand and contract more than the repaired stucco, so that leaks reappear.

Alternatively, the stucco coating 25 may be sawed with a diamond-tipped blade along edges of the window frame 22 to create gaps 30 that are then sealed with waterproof caulk. The saw blade typically leaves notches 33 that extend beyond corners of the window frame 22 by an inch or more. The notches can be unsightly even after they are caulked and painted. In addition, hairline cracks 35 in the stucco 25 may develop that propagate from the notches 33, further marring the appearance and further reducing the structural integrity of the stucco coating.

### SUMMARY

A method and apparatus for forming a waterproof building wall are disclosed, including providing a mold that fits around a window or other structure held in the wall, applying stucco or other moldable material that hardens to form an exterior coating for the wall and a recess from the mold, and sealing the recess with an elastic and waterproof sealant that is attached to both the structure and the side of the recess. The resulting wall may have a sealed recess between the stucco coating and the structure that extends less than about one centimeter from the structure, and the seal can expand and contract in conformance with expansion and contraction of a distance between the edge and the side surface.

### DESCRIPTION OF THE FIGURES

FIG. 1 is a cutaway side view of a prior art means for fixing a leaking window in a stucco wall.

FIG. 2 is a cutaway side view of a window contained in a stucco wall and having a molded recess sealed with a waterproof elastic seal.

FIG. 3 is a cutaway cross-sectional view of the stucco wall and window of FIG. 2.

FIG. 4 is an expanded cutaway cross-sectional view of a seal between the stucco wall and window of FIG. 3.

FIG. 5 is an expanded cutaway cross-sectional view of a seal between a one-coat stucco wall and a window structure, with a foam board disposed beneath the seal.

FIG. 6 is an expanded cutaway cross-sectional view of a seal between a one-coat stucco wall and a window structure, with a foam board disposed beside the seal.

FIG. 7 is a side view of a window having a removable mold fitting around the frame to shape the stucco wall of FIG. 2.

FIG. 8 is a cross-sectional view of the window and removable mold of FIG. 7.

FIG. 9 is an expanded cutaway cross-sectional view of the window frame and mold of FIG. 8.

FIG. 10 is a cutaway cross-sectional view of the window frame and a mold having an acute angle between the flange and the projection.

FIG. 11 is a side view of several individual molds that can be arranged to encircle a window frame.

FIG. 12 is a cutaway cross-sectional view of the window frame and mold of FIG. 9 with stucco formed around the mold.

FIG. 13 is a cutaway cross-sectional view of a mold that is held to window frame with tape.

FIG. 14 is another cutaway cross-sectional view of the mold of FIG. 13 held to window frame with tape at an angle to normal from an exterior surface of the frame.

FIG. 15 is a cutaway cross-sectional view of an L-shaped mold that is held to window frame with tape.

FIG. 16 is a cutaway cross-sectional view of a J-shaped mold that is held to window frame with tape.

### DETAILED DESCRIPTION OF THE PREFERRED EMBODIMENTS

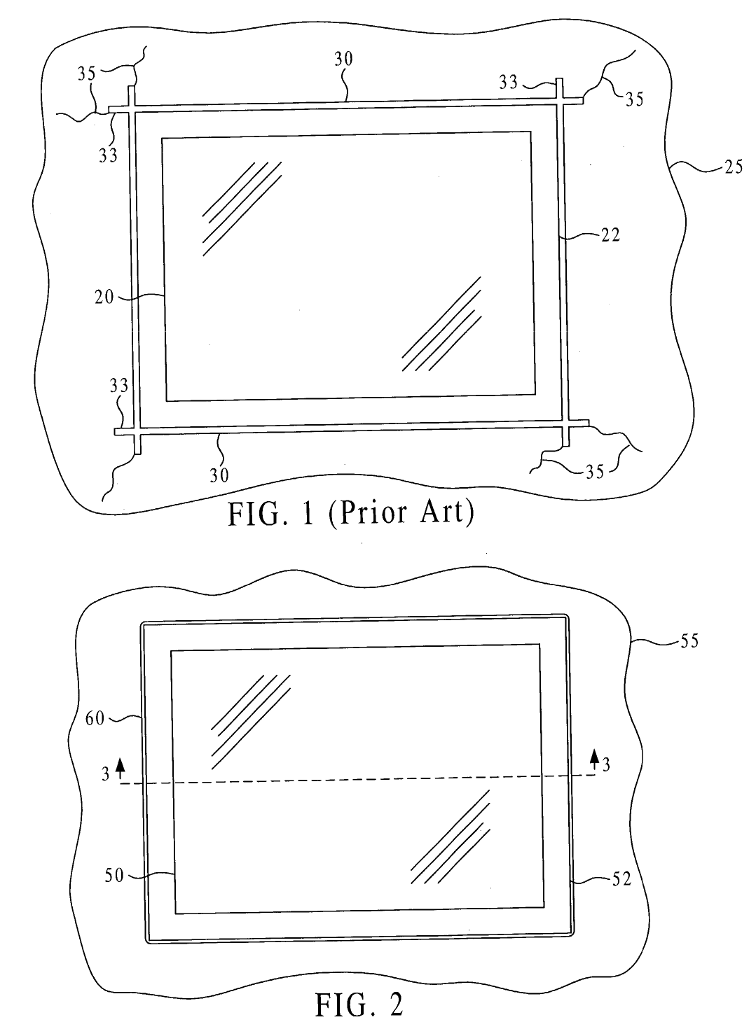

FIG. 2 shows a window 50 with a frame 52 that is attached to a wall that is coated with stucco 55. The window 50 and frame 52 may be generally rectangular as shown or may have a variety of other known window shapes, such as curved or circular, which are not shown but can also be employed with the invention. The frame 52 may be made of wood, aluminum and/or vinyl, or other known materials. The stucco 55 may be made of a single layer or several stucco layers, as described below. Also, other suitable materials may be used instead of stucco, such as plastic and/or cement, and other structures may be used instead of the window, such as pipes, doors, beams, vents, etc.

A molded recess 60 has been formed in the stucco 55 and filled with a waterproof elastic seal. In one embodiment, the recess and seal generally extend no more than about one centimeter (approximately one-half inch) from the outside edge of the window frame 52, eliminating the notches of the prior art and their various problems. In one embodiment, the recess and seal may extend from the frame between about two millimeters (approximately one-sixteenth inch) and six millimeters (approximately one-quarter inch), and preferably between about three millimeters (approximately one-eighth inch) and six millimeters (approximately three-eighths inch). In contrast with the prior art, the recess may be so thin that it may not need to be painted after it has been filled with sealant. The sealant may be available in various colors that match either the stucco or the frame so that the exposed sealant is not noticeable. An adherent layer, not shown, may be applied between the sealant and the paint, or the sealant may be painted while still tacky to affix the paint to the sealant.

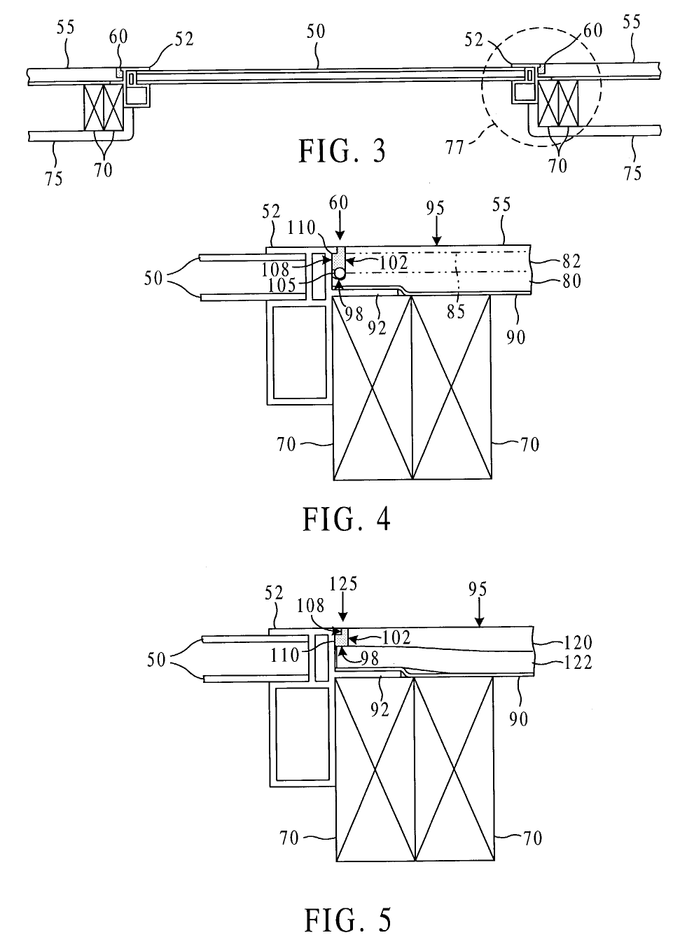

FIG. 3 shows a cross-sectional view of the stucco-coated wall and window of FIG. 2. Also shown in FIG. 3 are wall support members 70 such as wood or metal two-by-fours or two-by-sixes, and an interior coating 75 such as wallboard. For conciseness, the window 50 and frame 52 are illustrated as having a simple fixed double-pane structure.

FIG. 4 shows an expanded cross-sectional view of the area enclosed by the dashed circle 77 of FIG. 3. Stucco coating 55 can be seen in this embodiment to be made of three layers: a scratch coat 80, a brown coat 82 and a finish coat 85, which are applied in that order over a waterproof building paper layer 90. The finish coat 85 has an exterior surface 95 that may be exposed or painted. The stucco coating 55 may have an overall thickness of about two and one-quarter centimeters (approximately seven-eighths inch).

The window frame 52 has a fin 92 that is attached to the support members 70, for example by nailing. The recess 60 has a bottom surface 98 and a side surface 102, and the side surface is substantially perpendicular to the exterior surface 95 in this embodiment. Alternatively, the side surface 102 may slope toward the frame with increasing depth from the exterior surface 95, so that the recess adjacent to the bottom surface is essentially the same distance from the frame as that adjacent to the exterior surface, where the frame has a small lip. The recess may have a depth-to-width aspect ratio that is in a range between about one and about six.

A foam rod 105 may be disposed in the recess 60 adjacent to the bottom surface 98, and an elastic and waterproof sealant 110 fills the remainder of the recess to join with the side surface and with an edge 108 of the frame. The rod 105, which may be hydrophilic, ensures that the sealant 110 is disjoined from the bottom surface 98 despite being bonded to the side surface to the edge 108, and also reduces the depth-to-width aspect ratio of the remainder of the recess to facilitate filling the remainder of the recess with sealant. The sealant preferably can expand to several times its original thickness, remaining secured to the edge 108 and to the side surface of the recess even as the window frame contracts much more than stucco, expanding the distance between the edge 108 and the side surface. The sealant is also non-reactive with the window frame material, and the sealant may therefore differ depending upon the type of material used for the window frame. In one embodiment, the sealant is product number 1199 SSL silicone sealant available from Dow Corning Corp., PO Box 0994, Midland, Mich. 48686-0994, which is non-reactive with both vinyl and aluminum and has an expansion coefficient of approximately four. The expansion coefficient is a measure of how far a material can stretch without permanent deformation. This sealant typically does not provide a surface to which most paints adhere, but a paintable silicon layer can be applied as a kind of primer that provides adhesion for paint. Paint can then be applied while the primer is still tacky or after curing. In an alternative embodiment, a sealant that does not stretch as much but is paintable can instead be used, provided the sealant has an expansion ratio of at least one.

FIG. 5 is a cross-sectional view of an embodiment similar to that shown in FIG. 4 but having a single stucco layer 120 applied atop a board 122 that may be made of foam or wood. The embodiment shown in FIG. 5 may be termed a “one-coat” stucco process, as opposed to the “three-coat” process described with reference to FIG. 4, although it need not have only one coat atop the board 122. The foam or other board 122 may be a “blue board” that includes drip lines, available from Dow Corning at the above address, and the stucco layer 120 may include fibers and plastic as well as concrete. The frame for the one-coat process may have a greater distance between the fin 92 and the exterior surface 95 to allow for the board and stucco. In the embodiment of FIG. 5 the foam board 122 forms the bottom surface of the recess 98. As will be discussed, the stucco is formed to a mold that is then removed to leave a recess 125 that has a smaller depth-to-width aspect ratio than that of the embodiment of FIG. 4.

The sealant 110 may be selected to avoid adherence with the foam board 122, or the foam board may be coated with a material, such as a powder, paint or strip, that does not adhere well to the sealant. The waterproof and elastic sealant 110 is selected to adhere well to the side surface 102 and to the edge 108. Freeing the sealant from the bottom surface 98 helps the sealant remain affixed to the side surface 102 and to the edge 108 as the distance between the side surface and the edge changes, instead of pulling the sealant toward the bottom surface during expansion of that distance and pushing the sealant away from the bottom surface during contraction of that distance.

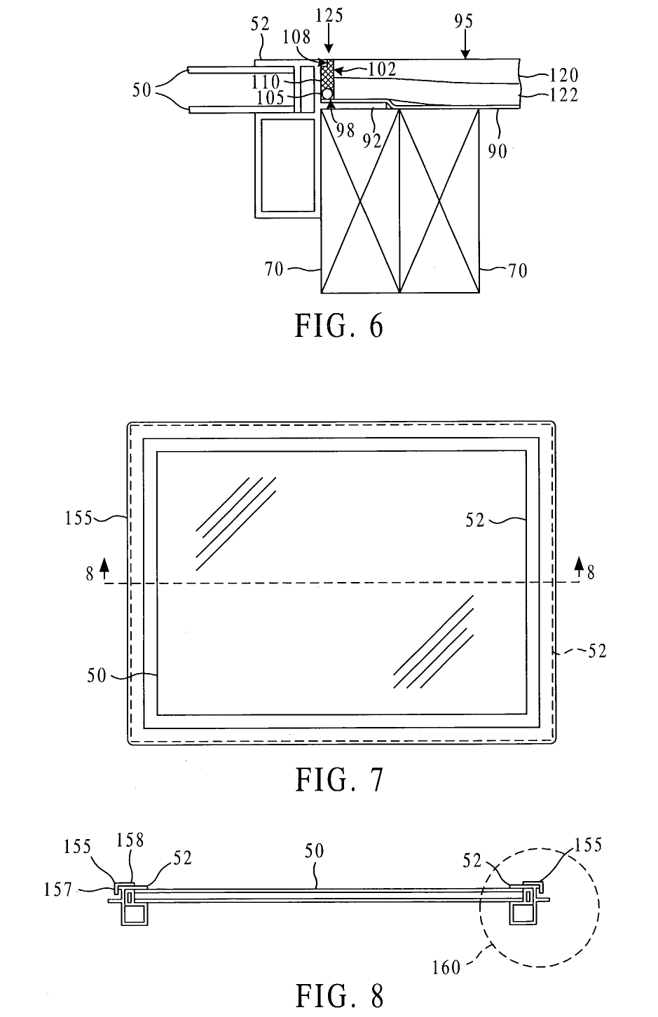

FIG. 6 is a cross-sectional view of an embodiment similar to that shown in FIG. 5, except that the foam board 122 terminates at the side surface 102 of the recess instead of extending beneath the bottom surface 98 of the recess. This can be formed by abutting the foam board 122 to a mold insert that is removed after the stucco has hardened, instead of abutting removable mold to the foam board to form the embodiment of FIG. 5. A foam rod 105 is disposed in the recess 125 adjacent to the bottom surface 98 to disjoin the sealant 110 from the bottom surface. The foam rod 105 may be termed a bond breaker and may be hydrophilic. Tape or other bond breaking material may be disposed in the recess adjacent to the bottom surface, instead of the foam rod. The foam board may have a thickness in a range between about two and one-half centimeters (approximately one inch) and about three centimeters (approximately one and one-quarter inch) and the stucco layer may have a thickness in a range between about six millimeters (approximately three-eighths inch) and about one centimeter (approximately one-half inch) in this embodiment.

FIG. 7 shows the window 50 with a removable mold 155 fitting around the window frame 52 to shape the stucco wall of FIG. 2, and thereby create any of the structures shown in FIG. 3 to FIG. 6. The mold 155 is shaped to fit closely around the window frame 52, which may be produced to tight tolerances by various window manufacturers. The mold may be provided with the window 50 or may be separately supplied and fitted to the window frame 52. The mold may be made of plastic, metal, wood or any other suitable material that detaches from the stucco to form a recess in the stucco layer adjacent to the frame.

FIG. 8 is a cross-sectional view of the window 50, frame 52 and mold 155 of FIG. 7. The mold 155 in this embodiment includes a projection 157 and a flange 158 that extend substantially at right angles to each other. The projection 157 is used for molding the stucco while the flange 158 helps to hold the projection 157 to the frame 52 at a correct and uniform depth from the face of the frame, creating a uniform recess in the stucco.

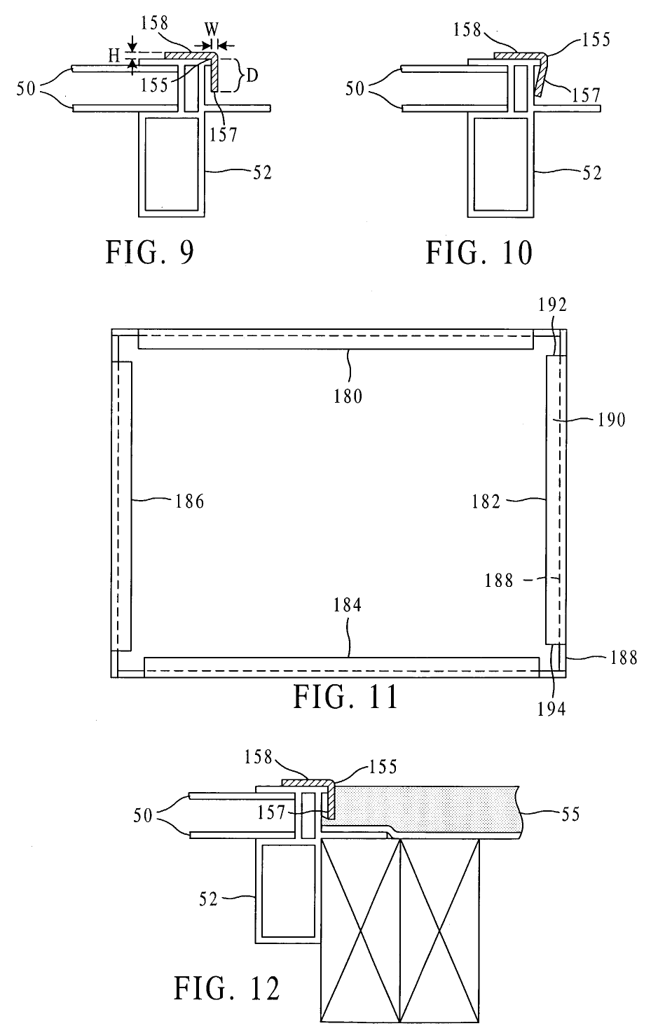

FIG. 9 shows an expanded cross-sectional view of the area enclosed by the dashed circle 160 of FIG. 8. Mold 155 can be seen in this embodiment to have a rounded corner that provides room for creating a textured finish for the stucco. Alternatively, the mold can have a square corner for creating a screed finish on the stucco. Projection 157 may have a depth D in a range between about three centimeters (approximately one and one-half inch) and about five millimeters (approximately one-quarter inch), depending upon the embodiment. Projection 157 may have a width W in a range between about two millimeters (approximately one-sixteenth inch) and six millimeters (approximately one-quarter inch), and preferably between about three millimeters (approximately one-eighth inch) and six millimeters (approximately three-eighths inch). Flange 158 may have a height H similar to the width W of the projection 157. Alternatively, the flange 158 may be thicker than the projection 157 to provide a more pronounced edge for guiding a stucco working tool such as a trowel, or the flange 158 may be reduced in thickness to allow a stucco tool such as a trowel to screed over the flange in forming an exterior surface of the stucco. In the latter case, flange 158 may have a height H in a range between about one millimeter and about three millimeters, and preferably about two millimeters (approximately one-sixteenth inch).

FIG. 10 is a cross-sectional view of an embodiment similar to that shown in FIG. 9, except that the projection 157 forms an acute angle with the flange 158. The recess formed in the stucco by projection 157 will have a side surface that is not perpendicular to the exterior surface of the stucco.

FIG. 11 shows several individual molds 180, 182, 184 and 186 that can be arranged to encircle a window frame. The molds 180, 182, 184 and 186 each have a projection and a flange that are at a right angle to each other, with the projections extending away from the viewer in this figure. Each of the projections also extends further than its attached flange along the elongate dimension of that mold, so that the flanges do not interfere with each other when the molds are attached to a window frame. For example, mold 182 has a projection 188 attached to a flange 190 that is clipped at its ends 192 and 194 so that the flange extends less than the projection in the elongate dimension of the mold. The individual molds 180, 182, 184 and 186 may be held to a window frame by tape, glue or similar means.

FIG. 12 shows mold 155 fitted on window frame 52 with stucco 55 formed up to the mold. After the stucco 55 has hardened and the mold 155 removed, a recess remains in the stucco where the projection 157 had been disposed. The recess can then be sealed with a bond breaking material and sealant as illustrated above.

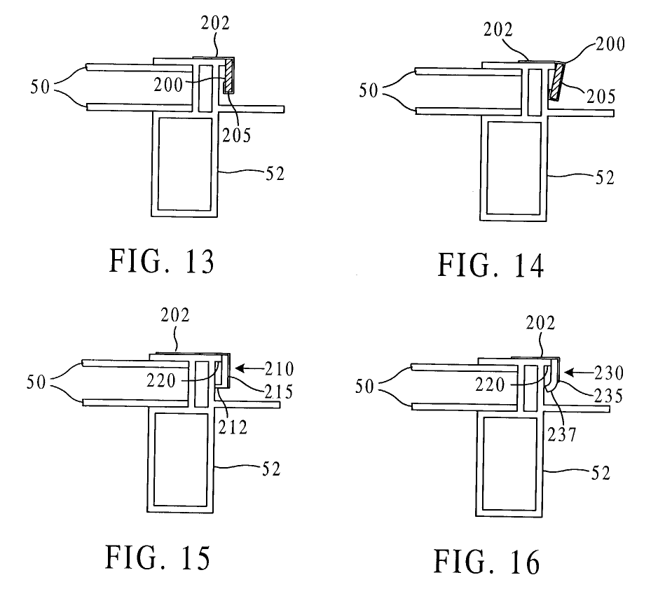

FIG. 13 shows a mold 200 held to a window frame 52 with tape 202 that wraps around a projection 205 to become part of the mold. The tape 202 has a reduced thickness (e.g., approximately one millimeter) to allow a stucco tool such as a trowel to screed over the tape to form an exterior surface of the stucco that is substantially coplanar with the frame 52.

FIG. 14 shows mold 200 held to window frame 52 with tape 202 such that the mold is not perpendicular to the frame surface to which the tape is attached. As mentioned above, the tape 202 has a thickness (e.g., two millimeters or less) to allow a stucco tool such as a trowel to screed over the tape to form an exterior surface of the stucco that is substantially coplanar with the frame 52.

FIG. 15 shows a mold 210 held to a window frame 52 with tape 202 that wraps around a projection 215 to become part of the mold. The mold has a lip 212 that extends from the projection 215 toward frame 52 a similar distance as a lip 220 of the frame extends away from the remainder of the frame, so that projection 215 extends in a direction perpendicular to the frame surface to which the tape is attached. The mold lip 212 may be thinner than the projection 215 to facilitate removal of the mold after the stucco or other moldable material has hardened.

FIG. 16 shows a mold 230 held to a window frame 52 with tape 202 that wraps around a projection 235 to become part of the mold. The mold has a lip 237 that extends from the projection 235 toward frame 52 a similar distance as a lip 220 of the frame extends away from the remainder of the frame, so that projection 235 extends in a direction perpendicular to the frame surface to which the tape is attached. The mold lip 237 may be curved to facilitate removal of the mold after the stucco or other moldable material has hardened. The molds shown in FIG. 15 and FIG. 16 may have particular utility for windows that have curved frames, such as arched or circular windows.

Although the present disclosure has focused on teaching the preferred embodiments, other embodiments and modifications of this invention will be apparent to persons of ordinary skill in the art in view of these teachings. Therefore, this invention is to be limited only by the following claims, which include all such embodiments and modifications when viewed in conjunction with the above specification and accompanying drawings.

1. A method of fabricating a building wall, the method comprising:
attaching a structure to a support for the wall;
holding a mold adjacent to an edge of the structure;
forming a coating over the support adjacent to the structure, including forming an exterior surface of the coating, and forming a side surface of the coating that substantially adjoins the mold;
removing the mold from the coating and from the edge to form a recess in the coating adjacent to the edge, including exposing the side surface of the coating; and
forming a substantially waterproof and elastic seal in the recess, including joining the seal to the edge and joining the seal to the side surface, such that the seal can expand and contract in conformance with expansion and contraction of a distance between the edge and the side surface.

2. The method of claim 1, wherein holding the mold adjacent to the edge of the structure occurs prior to attaching the structure to the support.

3. The method of claim 1, wherein holding the mold adjacent to the edge of the structure occurs after attaching the structure to the support.

4. The method of claim 1, wherein holding the mold adjacent to the edge of the structure includes substantially encircling the structure with the mold.

5. The method of claim 1, wherein the structure includes a window surrounded by a frame, and joining the seal to the edge includes attaching the seal to the frame.

6. The method of claim 1, wherein the wall includes stucco and joining the seal to the side surface of the wall includes attaching the seal to the stucco.

7. The method of claim 1, wherein the wall includes cement and joining the seal to the side surface of the wall includes attaching the seal to the cement.

8. The method of claim 1, wherein forming the coating over the support adjacent to the structure includes forming a bottom surface of the recess such that the side surface is disposed between the exterior surface and the bottom surface.

9. The method of claim 8, further comprising placing a material in the recess between the bottom surface and the seal, such that the material is disjoined from at least one of the bottom surface and the seal.

10. The method of claim 1, further comprising disjoining the seal from a bottom surface of the recess.

11. The method of claim 1, further comprising placing a material in the recess between the bottom surface and the seal such that the material is disjoined from at least one of the bottom surface and the seal.

12. The method of claim 1, further comprising selecting the seal from a group of materials that are not reactive with the structure.

13. The method of claim 1, further comprising painting the seal with a material that adheres to the seal and to the coating.

14. A building comprising:
a wall dividing an interior region of the building from a region exterior to the building, the wall having an exterior surface disposed adjacent to the exterior region;
a structure held in the wall, the structure including a part that is exposed to the exterior region;
a recess in the exterior surface that is disposed adjacent to the structure, the recess substantially encircling the structure and not extending more than about one centimeter away from the structure, the recess including a bottom surface and a side surface, the side surface being disposed between the exterior surface and the bottom surface; and
a waterproof and elastic seal that is disposed in the recess, the seal being joined to the structure and to the side surface of the recess, the seal being disjoined from the bottom surface, wherein the seal expands and contracts in conformance with expansion and contraction of a distance between the structure and the side surface.

15. The building of claim 14, wherein the part is a window.

16. The building of claim 15, wherein the window has a frame that includes vinyl, and the seal is made from a material that is non-reactive with vinyl.

17. The building of claim 14, wherein the wall includes cement.

18. The building of claim 14, wherein the wall includes stucco.

19. The building of claim 14, wherein the side surface is made of stucco.

20. The building of claim 14, wherein the side surface and the bottom surface are made of stucco.

21. The building of claim 14, wherein the side surface is made of stucco and the bottom surface is made of a foam board that extends beneath the stucco.

22. The building of claim 14, wherein the side surface is made of stucco and of a foam board that extends beneath the stucco.

23. The building of claim 14, wherein the wall includes plural layers, and the recess penetrates at least one but not all of the layers.

24. The building of claim 14, further comprising a rod disposed in the recess between the bottom surface and the seal, the rod being disjoined from at least one of the bottom surface and the seal.

25. The building of claim 14, further comprising a rod that is disposed in the recess between the bottom surface and the seal, the rod having a diameter that is greater than the distance between the structure and the side surface as measured adjacent to the exterior surface.

26. The building of claim 14, wherein the seal includes a material having an expansion index of at least one.

27. The building of claim 14, wherein the seal is made from a material that is non-reactive with the structure.

28. The building of claim 14, wherein the side surface is substantially perpendicular to the exterior surface.

29. The building of claim 14, wherein the recess has been formed by molding stucco.

30. An apparatus for a building wall including stucco, the apparatus comprising:
a window having a frame that is sized to fit in the wall; and
a removable mold fitting around the frame to shape the stucco, the mold including a projection having a width extending beyond the frame by not greater than about one centimeter, the projection having a depth measured in a direction that is substantially perpendicular to the width, the depth being greater than the width, the mold being made of a material that detaches from the stucco to form a recess in the stucco adjacent to the frame.

31. The apparatus of claim 30, wherein the depth is less than about one centimeter.

32. The apparatus of claim 30, wherein the stucco is shaped as a layer having a thickness, and the depth is less than the thickness.

33. The apparatus of claim 30, wherein the width is not greater than about three millimeters.

34. The apparatus of claim 30, wherein the mold includes a flange that fits on a face of the frame, the flange having a height measured in an opposite direction as the depth, the height being not greater than about two millimeters.

35. The apparatus of claim 30, wherein the mold is attached to the frame with a tape.

36. An apparatus for a building having a window held in a wall, the apparatus comprising:
molding means for molding a recess in an exterior surface of the wall adjacent to the window, the recess substantially encircling the window and having a side surface that is disposed adjacent to the exterior surface; and
holding means for holding the molding means to the window.
